(19) United States
(12) Patent Application Publication
(10) Pub. No.: US 2021/0019793 A1
(43) Pub. Date: Jan. 21, 2021

(54) INFORMATION PROCESSING APPARATUS AND INFORMATION PROCESSING METHOD

(71) Applicant: Bank Invoice Corporation, Tokyo (JP)

(72) Inventor: Taro Teshima, Tokyo (JP)

(21) Appl. No.: 17/036,247

(22) Filed: Sep. 29, 2020

Related U.S. Application Data
(63) Continuation of application No. PCT/JP2018/013382, filed on Mar. 29, 2018.

(51) Int. Cl. G06Q 30/04; G06Q 20/10; G06Q 20/38

(52) U.S. Cl. CPC G06Q 30/04; G06Q 20/389; G06Q 20/388; G06Q 20/102

(57) ABSTRACT

An invoice management apparatus stores, when receiving invoice data addressed to a specified recipient, over a network, the invoice data in association with the identification information of its recipient and issuer in an invoice data management table, and also stores intention information about the payment intention of the recipient in the invoice data management table. A data processing unit is provided to refer to, when receiving a request for paying in advance part of the billing amount on the invoice data from the issuer or recipient, the invoice data management table to confirm the intention information, and if the recipient has a payment intention, deposits the requested amount in advance to the designated account of the issuer, stores the paid and unpaid amount out of the billing amount in a credit and debt management table, and deposits the unpaid amount to the designated account on the payment due date.

### RELATED APPLICATIONS

This application claims priority under 35 U.S.C. § 120 to, and is a continuation of, co-pending International Application PCT/JP2018/013382, filed Mar. 29, 2018 and designating the US. This International application is incorporated by reference herein in its entirety.

### BACKGROUND

### Field

The embodiment discussed herein relates to an information processing apparatus and an information processing method.

There is known a technique for achieving unified management for viewing of business documents (for example, invoices and others) of an entire company or an entire corporate group and information thereof.

For example, there is known an information processing apparatus that has a first storage unit that stores therein user information associating user identification information identifying a user and at least one piece of unique information with each user, a generation unit that generates a code for each user from the unique information and user identification information stored in the first storage unit, under prescribed rules, a second storage unit that stores therein business document information including the user identification information of a first user that is included in the user information stored in the first storage unit, and a processing unit that determines, when receiving a request for access to business document information from a second user whose user information is stored in the first storage unit, whether the first code of the first user matches the second code of the second user, and when the first code matches the second code, gives the second user an access authority to access the business document information created by the first user and stored in the second storage unit.

Please see, for example, International Publication Pamphlet No. WO 2015/049948.

There may be a desire to receive in advance part of the billing amount on an invoice issued. In this case, the accounting personnel on the money receiving side may contact the accounting personnel on the payer side. However, a procedure for the advance payment, such as recording of the paid amount on the payer side, may be complicated.

### SUMMARY

To accomplish the above problem, there is provided an information processing apparatus including: a first memory that stores therein, upon receipt of business document data addressed to a specified recipient, from a terminal device over a network, the received business document data in association with identification information of the recipient and identification information of an issuer of the business document data, and intention information about a payment intention of the recipient; and a processing unit that is coupled to the first memory and is configured to perform a process including accessing, upon receipt of a request for paying in advance at least part of a billing amount indicated in the business document data from the issuer or the recipient, the first memory to confirm the intention information, paying in advance a requested amount to a designated account of the issuer upon determining that the recipient has a payment intention, storing the paid amount and an unpaid amount out of the billing amount indicated in the business document data in association with each other in a second memory, and paying the unpaid amount stored in the second memory to the designated account of the issuer on a payment due date, wherein the process further includes storing the intention information in the first memory, based on an action made on business document data by the recipient actually viewing the business document data among the received business document data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an invoice management system according to a first embodiment.

FIG. 2 is a view for explaining an example of a screen that is displayed on a terminal device after a login.

FIG. 3 illustrates a hardware configuration of an invoice management apparatus according to the embodiment.

FIG. 4 is a block diagram illustrating functions of the invoice management apparatus according to the embodiment.

FIG. 5 is a view for explaining an example of invoice data.

FIG. 6 is a view for explaining an example of account data.

FIG. 7 is a view for explaining an example of credit and debt data.

FIG. 8 is a view for explaining information that is displayed in a summary display area.

FIG. 9A is a view for explaining information that is displayed in a summary display area.

FIG. 9B is a view for explaining invoice data that is displayed in the summary display area.

FIG. 10 is a view for explaining an example of external communication data.

FIG. 11 is a view for explaining an example of attached file data.

FIG. 12 is a view for explaining an example of data that is stored in a history data storage unit.

FIG. 13 is a view for explaining an example of data that is stored in a history data storage unit.

FIG. 14 is a view for explaining an example of memo data.

FIG. 15 is a view for explaining how an invoice management apparatus operates.

### DETAILED DESCRIPTION

Hereinafter, an invoice management system according to one embodiment will be described in detail with reference to the accompanying drawings.

### First Embodiment

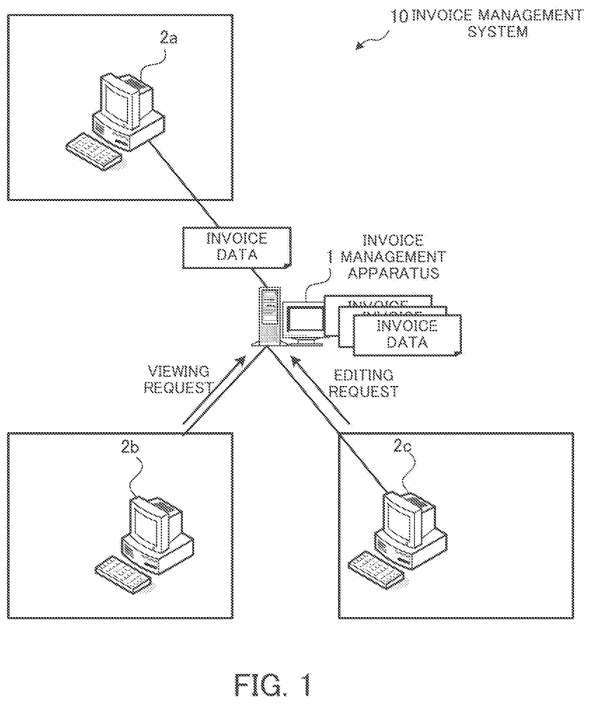

FIG. 1 illustrates an invoice management system according to a first embodiment.

In the invoice management system 10 of the first embodiment, an invoice management apparatus 1 is connected to terminal devices 2a, 2b, and 2c over the Internet or a dedicated network.

The terminal devices 2a, 2b, and 2c are placed at accounting departments of different companies. For example, the terminal device 2a is placed at a company A, the terminal device 2b is placed at a company B, and the terminal device 2c is placed at a company C. Examples of the terminal devices 2a, 2b, and 2c include desktop personal computers, laptop personal computers, tablet terminals, and smartphones.

A web program is installed in the invoice management apparatus 1 and the terminal devices 2a, 2b, and 2c. The terminal devices 2a, 2b, and 2c communicate invoice data on invoices with the invoice management apparatus 1 through Web browsers. In this connection, the present embodiment explains communication of invoice data, but invoices are an example of business documents and the present embodiment is not limited thereto. Other examples of business documents include estimate forms and order forms.

Hereinafter, it is assumed that the invoice management system 10 is used by the individual accounting personnel of the companies A, B, and C.

Each accounting personnel of the companies A, B, and C performs user registration to the invoice management apparatus 1 using an assigned Email address or the like, in order to set up a connection to an invoice processing system provided by the invoice management apparatus 1.

After that, for example, the accounting personnel of the company A operates the terminal device 2a to display a login screen provided by the invoice management apparatus 1 on a monitor connected to the terminal device 2a. The accounting personnel enters his/her mail address and password on the login screen, thereby logging in to the service provided by the invoice management apparatus 1. In this connection, the mail address is an example of identification information identifying the accounting personnel.

After the login, the accounting personnel are able to operate their terminal devices 2a, 2b, and 2c to process invoice data, which is a digitized version of original invoices, via the invoice management apparatus 1. The processing of invoice data include creation, sending, receipt, viewing, editing, and others.

For example, when the accounting personnel of the company A issues an invoice to the company B, the accounting personnel of the company A operates the terminal device 2a to create the invoice with the company B designated as a bill-to party, on a management screen that is displayed after a login. Then, the accounting personnel sends the invoice data with the mail address of the accounting personnel (recipient) of the company B designated as a destination of the created invoice. The sent invoice data is held by the invoice management apparatus 1.

That is, the invoice data is not communicated directly between the terminal devices 2a, 2b, and 2c. Rather, all invoice data created by the terminal devices 2a, 2b, and 2c and sent to bill-to parties is held by the invoice management apparatus 1. The invoice data is treated like shared data. The invoice management apparatus 1 gives viewing and editing authorities for the invoice data to the terminal devices 2a, 2b, and 2c according to necessity.

The above approach makes it possible to digitize and process original invoices electronically, which leads to saving labor for management and storage of paper- or PDF-based invoices.

As described earlier, invoice data is not communicated directly between the terminal devices 2a, 2b, and 2c. In the following description, however, in the case where invoice data addressed to the mail address of the accounting personnel of the company B is sent from the accounting personnel of the company A, for example, an expression like “the accounting personnel receives the invoice data” may be used, as in the general communication of invoice data, for easy understanding.

In this connection, it is preferable that invoice data be communicated in an encrypted form between the invoice management apparatus 1 and each terminal device 2a, 2b, 2c.

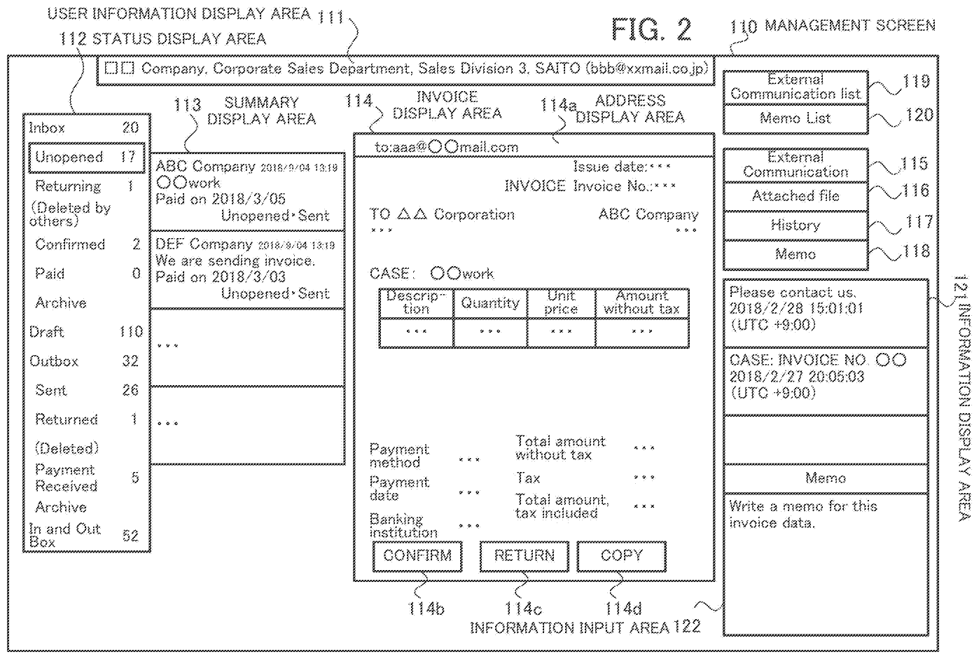

FIG. 2 is a view for explaining an example of a screen that is displayed on a terminal device after a login.

The management screen 110 illustrated in FIG. 2 is an example of a screen that is displayed on the terminal device 2a.

As illustrated in FIG. 2, an accounting personnel is able to create, issue, view, and edit invoice data, like he/she uses mail software.

By the way, in the above-described example, the accounting personnel of the company A is not able to rewrite invoice data once he/she sends it. In addition, the accounting personnel of the company B is also not able to rewrite the invoice data. If the invoice data contains an error, another version of the invoice data needs to be issued. In this connection, the old version of the invoice data is held by the invoice management apparatus 1, without being deleted, such as to be viewable at any time. To this end, the invoice management apparatus 1 performs version management of the invoice data, so as to easily search for a new version of the invoice data on the basis of an old version of the invoice data or for an old version of the invoice data on the basis of a new version of the invoice data.

The management screen 110 will be described in detail later.

Now, the disclosed invoice management system will be described more concretely.

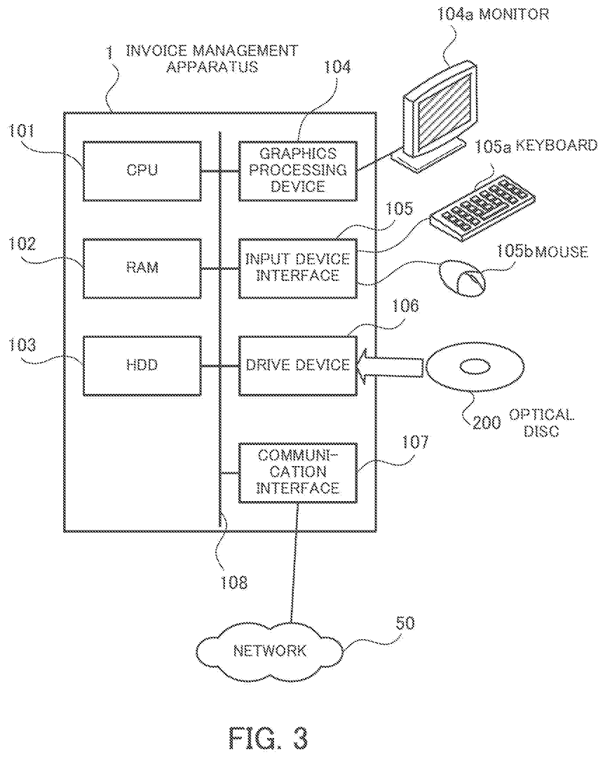

FIG. 3 illustrates a hardware configuration of the invoice management apparatus according to the present embodiment.

The invoice management apparatus 1 is entirely controlled by a CPU (central processing unit) 101. A RAM (random access memory) 102 and a plurality of peripheral devices are connected to the CPU 101 via a bus 108.

The RAM 102 is used as a main storage device of the invoice management apparatus 1. The RAM 102 temporarily stores therein at least part of an OS (operating system) program and an application program that are executed by the CPU 101. In addition, the RAM 102 stores therein various kinds of data to be used by the CPU 101 in processing.

Connected to the bus 108 are a HDD (hard disk drive) 103, a graphics processing device 104, an input device interface 105, a drive device 106, and a communication interface 107.

The HDD 103 magnetically writes and reads data on a built-in disk. The HDD 103 is used as an auxiliary storage device of the invoice management apparatus 1. An OS program, application programs, and various kinds of data are stored in the HDD 103. A semiconductor storage device, such as a flash memory, may be used as the auxiliary storage device.

The graphics processing device 104 is connected to a monitor 104a. The graphics processing device 104 displays images on a screen of the monitor 104a in accordance with instructions from the CPU 101. Examples of the monitor 104a include a display device using CRT (cathode ray tube) and a liquid crystal display.

The input device interface 105 is connected to a keyboard 105a and a mouse 105b. The input device interface 105 gives signals output from the keyboard 105a and mouse 105b to the CPU 101. The mouse 105b is an example of a pointing device, and another kind of pointing device may be used. Other examples of the pointing device include a touch panel, a tablet, a touchpad, and a trackball.

The drive device 106 reads data from, for example, a portable recording medium such as an optical disc, on which data is recorded so as to be readable with reflection of light, or a USB (universal serial bus) memory. For example, in the case where the drive device 106 is an optical drive device, data recorded on an optical disc 200 may be read with laser light or the like. Examples of the optical disc 200 include Blu-ray (registered trademark), DVD (digital versatile disc), DVD-RAM, CD-ROM (Compact Disc Read Only Memory), CD-R (Recordable), and CD-RW (ReWritable).

The communication interface 107 is connected to a network 50. The communication interface 107 communicates data with another computer or communication device over the network 50.

With the above hardware configuration, the processing functions of the present embodiment may be implemented. In this connection, FIG. 3 illustrates a hard configuration of the invoice management apparatus 1. The other computers including the terminal device 2a may be implemented with the same hardware configuration as the invoice management apparatus 1.

The invoice management apparatus 1 having the hardware configuration illustrated in FIG. 3 has the following functions.

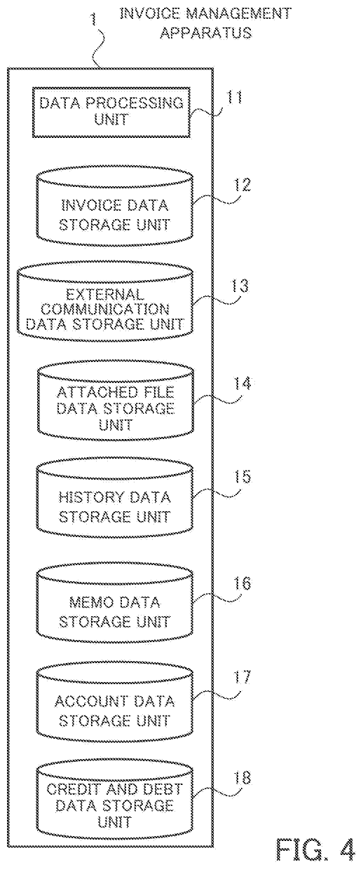

FIG. 4 is a block diagram illustrating functions of the invoice management apparatus according to the present embodiment.

The invoice management apparatus 1 has a data processing unit 11, an invoice data storage unit 12, an external communication data storage unit 13, an attached file data storage unit 14, a history data storage unit 15, a memo data storage unit 16, an account data storage unit 17, and a credit and debt data storage unit 18.

The data processing unit 11 displays the management screen 110 illustrated in FIG. 2 on the terminal device 2a or the like in accordance with accounting personnel's operations. The data processing unit 11 performs appropriate processing according to operations made to invoice data on the management screen 110. For example, the data processing unit 11 classifies and stores invoice data received by the invoice management apparatus 1, external communications (to be described later) and memos made by an accounting personnel, and others in appropriate storage units.

In addition, the data processing unit 11 have authority to access the bank account of each company and withdraw part or all of the amounts indicated on invoices.

In this connection, although this embodiment describes a process using a real currency, it is applicable to a process using virtual currencies. In the case of virtual currencies, the data processing unit 11 has authority to access accounts for each virtual currency.

The invoice data storage unit 12 stores therein invoice data received by the invoice management apparatus 1, by accounting personnel (more specifically, by mail address of accounting personnel). The invoice data received by the invoice management apparatus 1 includes invoice data sent from the accounting personnel of billers to the accounting personnel of bill-to parties and invoice data drafted by the accounting personnel (issuers) of the billers

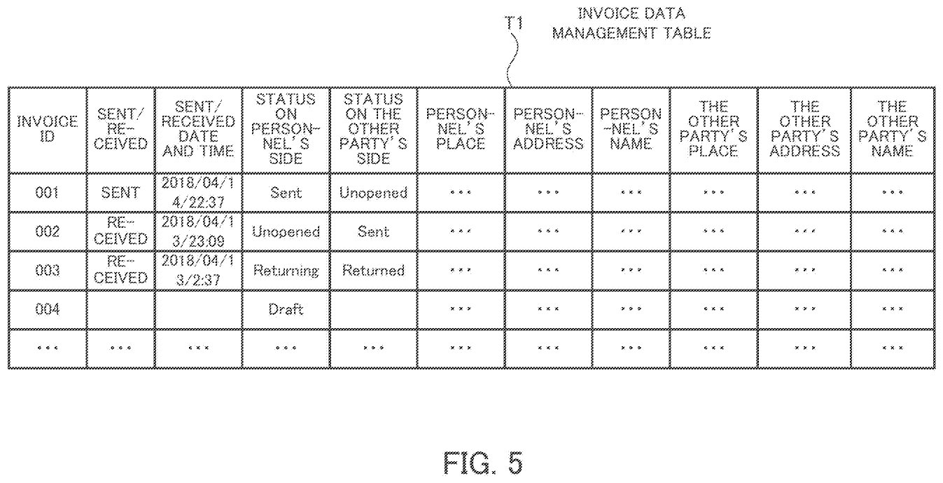

FIG. 5 is a view for explaining an example of invoice data.

In the present embodiment, data is stored in tabular form.

The invoice data management table T1 has the following columns: Invoice ID, Sent/Received, Sent/Received Date and Time, Status on Personnel's Side, Status on the Other Party's Side, Personnel's Place, Personnel's Address, Personnel's Name, The Other Party's Place, The Other Party's Address, and The Other Party's Name. Information pieces arranged in horizontal direction are associated with each other.

The Invoice ID column contains an ID unique to invoice data for use in management of invoice data. When the invoice management apparatus 1 receives invoice data, the data processing unit 11 gives an invoice ID to the invoice data.

The Sent/Received column indicates whether the invoice data is data that has been received or sent, in view of the accounting personnel. More specifically, “Received” indicates that the invoice data is received data, whereas “Sent” indicates the invoice data is sent data.

The Sent/Received Date and Time column contains the latest date and time among dates and times when the invoice data was sent and received.

The Status on Personnel's Side column contains the status (processing progress) of the invoice data in view of the accounting personnel.

The Status on the Other Party's Side column contains the status of the invoice data in view of the accounting personnel of the other party that communicates the invoice data.

The statuses to be set in the Status on Personnel's Side and Status on the Other Party's Side columns include the following: “Unopened,” “Returning,” “Deleted by the Other Party,” “Confirmed,” “Paid,” “Archive,” “Sent,” “Returned,” “Deleted,” and “Payment Received.” These statuses will be described in detail later.

The Personnel's Place column contains the names of the company and department to which the accounting personnel belongs.

The Personnel's Address column contains the mail address of the accounting personnel.

The Personnel's Name column contains the name of the accounting personnel.

The Other Party's Place column contains the names of the company and department to which the accounting personnel of the other party that communicates the invoice data belongs.

The Other Party's Address column contains the mail address of the accounting personnel of the other party that communicates the invoice data.

The Other Party's Name column contains the name of the other party that communicates the invoice data.

In addition to the illustrated information, the invoice data management table contains data on invoices, including the postal codes and addresses of both companies, breakdown items, and a billing amount.

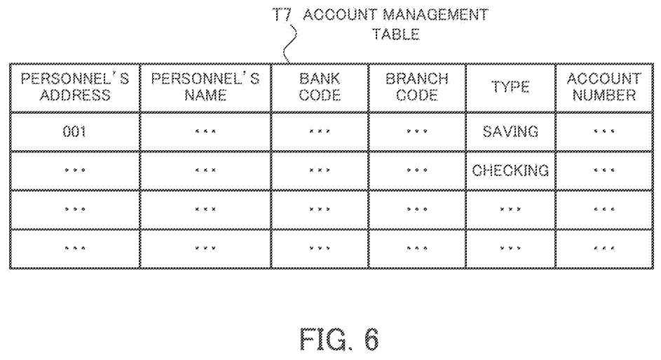

FIG. 6 is a view for explaining an example of account data.

In the embodiment, data is stored in tabular form.

The account management table T7 has the following columns: Personnel's Address, Personnel's Name, Bank Code, Branch Code, Type, and Account Number. Information pieces arranged in horizontal direction are associated with each other. Columns that contain the same contents as in other tables will not be described again.

The Bank Code, Branch Code, Type, and Account Number columns contain the bank code and branch code of a bank, an account type, and an account number for deposit or withdrawal of the amount indicated in each invoice.

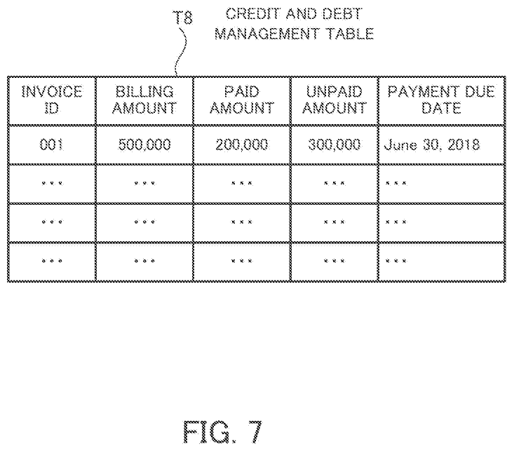

FIG. 7 is a view for explaining an example of credit and debt data.

In the embodiment, data is stored in tabular form.

The credit and debt management table T8 has the following columns: Invoice ID, Billing Amount, Paid Amount, Unpaid Amount, and Payment Due Date. Information pieces arranged in horizontal direction are associated with each other. Columns that contain the same contents as in other tables will not be described again.

The Billing Amount column contains the billing amount indicated on an invoice with corresponding invoice ID.

The Paid Amount column contains an amount already paid out of the billing amount.

The Unpaid Amount column contains an amount yet to be paid out of the billing amount.

The Payment Due Date column contains the due date for paying the billing amount.

The following describes a management screen.

### Management Screen

The data processing unit 11 displays the management screen 110 illustrated in FIG. 2 on the terminal device 2a or the like in accordance with accounting personnel's operations.

The management screen 110 has a user information display area 111, a status display area 112, a summary display area 113, an invoice display area 114, an External Communication button 115, an Attached File button 116, a History button 117, a Memo button 118, an External Communication List display button 119, a Memo List display button 120, an information display area 121, and an information input area 122.

The user information display area 111 displays information (user information) on an accounting personnel that has logged in to the invoice management system. Referring to FIG. 2, the user information display area 111 displays the names of a company and department to which the accounting personnel belongs, and the surname and mail address of the accounting personnel.

The status display area 112 displays the number of pieces of invoice data that is handled by the accounting personnel that has logged in to the invoice management system, for each status.

Roughly, the status display area 112 includes the following folders: Inbox, Draft, Outbox, and In and Out Box.

The data processing unit 11 places invoice data with the mail address of the accounting personnel designated as a recipient, into the Inbox folder.

When the accounting personnel selects the Inbox folder, the data processing unit 11 refers to the invoice data management table T1. Then, the data processing unit 11 displays, in the summary display area 113, the summary of invoice data that has “Received” in the Sent/Received column, among invoice data that has “bbb@xxmail.co.jp” in the Personnel's Address column.

As illustrated in FIG. 2, invoice data placed in the Inbox folder has the following statuses: “Unopened,” “Returning,” “Deleted by the Other Party,” “Confirmed,” “Paid,” and “Archive.”

The “Unopened” status is given by the data processing unit 11 to invoice data that has not been confirmed by the accounting personnel among the invoice data placed in the Inbox folder.

The “Returning” status is given by the data processing unit 11 to invoice data that has been returned from the accounting personnel to the accounting personnel of the biller among the invoice data placed in the Inbox folder.

The “Deleted by the Other Party” status is given by the data processing unit 11 to invoice data that has been received, returned by the accounting personnel to the accounting personnel of the biller, and then deleted by the accounting personnel of the biller, among the invoice data placed in the Inbox folder.

The “Confirmed” status is given by the data processing unit 11 to invoice data which the accounting personnel has viewed and for which the accounting personnel has selected a Confirm button (to be described later), among the invoice data placed in the Inbox folder.

The “Paid” status is given by the data processing unit 11 to invoice data for which the accounting personnel has made payment and then selected a Payment button, among the invoice data placed in the Inbox folder.

The accounting personnel compiles the invoice data in the Paid status to confirm the details of the payment.

The “Archive” status is given by the data processing unit 11 to invoice data which the account personnel has saved in an archive at certain timing, among the invoice data in the “Paid” status.

A number displayed in association with each status in the status display area 112 indicates the number of pieces of invoice data in the status.

For example, the Unopened status in the status display area 112 indicates the number of pieces of invoice data that have not been confirmed by the accounting personnel among received invoice data.

In this connection, the Archive status in the status display area 112 does not specifically indicate any number.

When the accounting personnel would like to view the contents of invoice data in a desired one of the “Unopened,” “Retuning,” “Deleted by the Other Party,” “Confirmed,” “Paid,” and “Archive” statuses, he/she just selects the desired status in the status display area 112.

For example, when the accounting personnel selects the Unopened status, the data processing unit 11 refers to the invoice data management table T1. The data processing unit 11 then displays the summary of the invoice data having Unopened in the Status on Personnel's Side column among the invoice data having “bbb@xxmail.co.jp” in the Personnel's Address column, in the summary display area 113.

The data processing unit 11 places invoice data that has been created and saved by the accounting personnel but has not been sent to the accounting personnel of the recipient, in the Draft status.

The data processing unit 11 places invoice data that has been sent by the accounting personnel, into the Outbox folder.

When the accounting personnel selects the Outbox folder, the data processing unit 11 refers to the invoice data management table T1. The data processing unit 11 then displays the summary of the invoice data having “Sent” in the Sent/Received column among the invoice data having “bbb@xxmail.co.jp” in the Personnel's Address column, in the summary display area 113.

As illustrated in FIG. 2, invoice data placed in the Outbox folder has the following statuses: “Sent,” “Returned,” “Deleted,” “Payment Received,” and “Archive.”

The “Sent” status is given by the data processing unit 11 to invoice data for which the accounting personnel of the bill-to party has not made payment, among the invoice data placed in the Outbox folder.

The “Returned” status is given by the data processing unit 11 to invoice data that has been returned from the accounting personnel of the bill-to party, among the invoice data placed in the Outbox folder. The accounting personnel is able to process the invoice data returned from the bill-to party.

The “Deleted” status is given by the data processing unit 11 to invoice data that has been deleted by the accounting personnel of the biller, among the invoice data returned from the accounting personnel of the bill-to party.

The “Payment Received” status is given by the data processing unit 11 to invoice data for which the accounting personnel of the biller has confirmed payment and selected a Payment Received button, among the invoice data placed in the Outbox folder.

The “Archive” status is given by the data processing unit 11 to invoice data which the accounting personnel has saved in the Archive at certain timing, among the invoice data in the “Payment Received” status.

The Archive status in the status display area 112 does not specifically indicate any number.

What is needed to view the contents of invoice data in a desired one of the “Sent,” “Returned,” “Deleted,” “Payment Received,” and “Archive” statuses is just to select the desired status.

The summary display area 113 displays the summary of invoice data corresponding to a status selected by the accounting personnel in the status display area 112, as described earlier. The summary of received invoice data may include the company name of a biller, a case name, a payment date and time, a status on the sender side, and a status on the recipient side.

The same statuses are displayed on the management screens of both the accounting personnel who has sent invoice data and the accounting personnel who has received the invoice data.

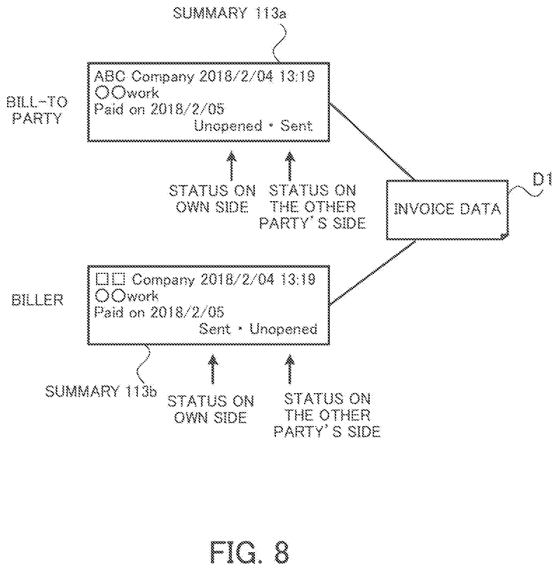

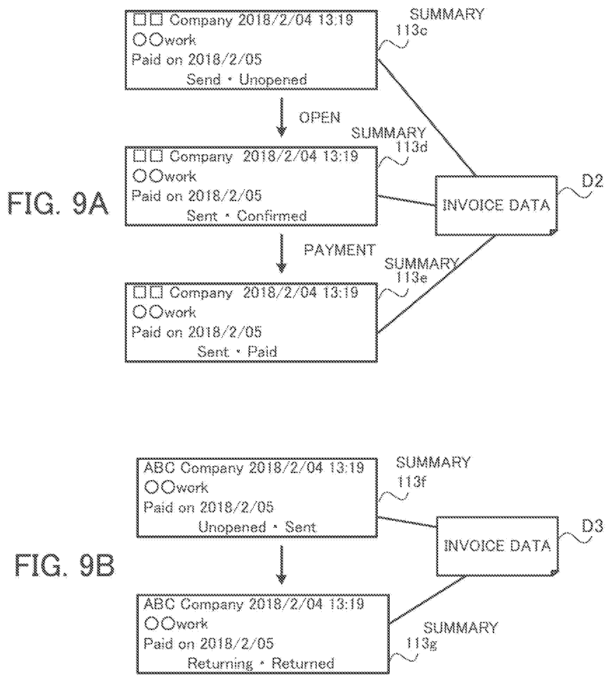

FIGS. 8 and 9 are views for explaining information that is displayed in the summary display area.

FIG. 8 illustrates a summary 113a of invoice data that is displayed in the summary display area 113 of the management screen 110 viewed by the accounting personnel of the bill-to party, and a summary 113b that is displayed in the summary display area 113 of the management screen 110 viewed by the accounting personnel of the biller.

More specifically, invoice data D1 with a biller of ABC company and a case name of OO work, as illustrated in FIG. 8, is in the “Sent” status in the status display area on the management screen of the terminal device operated by the accounting personnel of the biller. When the accounting personnel of the biller selects the “Sent” status in the status display area, the following information is displayed with respect to the invoice data D1 in the summary display area 113: a bill-to party is □□ company, a case name is OO work, a status on the accounting personnel's side of the biller is “Sent,” and a status on the accounting personnel's side of the bill-to party is “Unopened.”

By confirming status transitions, the accounting personnel of the biller is able to easily confirm the progress of processing made by the accounting personnel of the bill-to party. That is to say, the accounting personnel of both parties are able to confirm the current status of each invoice data in real-time.

All summaries 113c, 113d, and 113e illustrated in FIG. 9A are of invoice data D2.

When the accounting personnel of the bill-to party has viewed the invoice data D2 and selected a Confirm button (to be described later), the data processing unit 11 changes information displayed in the summary display area 113 from the summary 113c to the summary 113d on the management screen 110 of the terminal device operated by the accounting personnel of the biller.

After that, when the accounting personnel of the bill-to party has made payment for the invoice data D2 and selected a Paid button, the data processing unit 11 changes information displayed in the summary display area 113 from the summary 113d to the summary 113e on the management screen 110 of the terminal device operated by the accounting personnel of the biller.

As another example, both summaries 113f and 113g illustrated in FIG. 9B are of invoice data D3.

When the accounting personnel of the bill-to party has viewed the invoice data D3 and selected a Return button (to be described later), the data processing unit 11 changes information displayed in the summary display area 113 from the summary 113f to the summary 113g on the management screen of the terminal device operated by the accounting personnel of the bill-to party.

Refer now back to FIG. 2.

When the accounting personnel has selected the summary of invoice data being displayed in the summary display area 113, the data processing unit 11 displays the contents of the invoice in the invoice display area 114. The contents of the invoice to be displayed in the invoice display area 114 are the same as those of existing (paper-based or PDF-based) invoices, except that an address display area 114a and various buttons, which will be described later, are displayed.

When the accounting personnel views invoice data placed in the Inbox folder, the data processing unit 11 displays the mail address of a sender accounting personnel (from) in the address display area 114a.

When the accounting personnel views invoice data placed in the Draft status or Outbox folder, the data processing unit 11 displays the mail address of a recipient accounting personnel (to).

In this connection, the data processing unit 11 may display the invoice ID of the invoice data in the invoice display area 114.

The accounting personnel is able to process an invoice being displayed in the invoice display area 114 on the management screen 110.

More specifically, buttons for processing the invoice are displayed in the invoice display area 114 according to the status of the invoice data.

FIG. 2 illustrates buttons that are displayed when invoice data in the Unopened status is selected.

The invoice display area 114 includes a Confirm button 114b, a Return button 114c, and a Copy button 114d.

When the accounting personnel selects the Confirm button 114b, the data processing unit 11 refers to the invoice data management table T1. The data processing unit 11 then changes the Status on Personnel's Side column to “confirmed” with respect to the invoice data being displayed in the invoice display area 114. In addition, the data processing unit 11 decreases the number for the “Unopened” status by one and increases the number for the “Confirmed” status by one in the status display area 112.

When the accounting personnel selects the Return button 114c, the data processing unit 11 refers to the invoice data management table T1. The data processing unit 11 then changes the Status on Personnel's Side column to “returning” with respect to the invoice data being displayed in the invoice display area 114, and then changes the Status on the Other Party's Side column to “returned”. In addition, the data processing unit 11 decreases the number for the “Unopened” status by one and increases the number for the “Returning” status by one in the status display area 112.

On the management screen of the accounting personnel who has received the returned invoice data, the number for the Returned status in the status display area is increased by one.

When the accounting personnel selects the Copy button 114d, the data processing unit 11 creates new invoice data by replacing the company name and address between the biller and the bill-to party in the invoice data. Then, the data processing unit 11 stores information on the created invoice data in the invoice data management table T1. At this time, with respect to the invoice data, “Draft” is set in the Status on Personnel's Side column and a blank is set in the Status on the Other Party's Side column.

Refer back to FIG. 2.

Among all invoice data placed in the Inbox and Outbox folders, data other than deleted invoice data, invoice data saved in the archive, and invoice data in the Draft status is placed in the In and Out Box folder.

### External Communication Button

When the accounting personnel selects the External Communication button 115, the data processing unit 11 switches the management screen 110 into an external communication input mode. In this external communication input mode, when the accounting personnel enters text (text data) in the information input area 122 and presses the enter key of a keyboard or the like to fix this operation, the data processing unit 11 stores, as an external communication, the text data in the external communication data storage unit 13 in association with the mail address of the accounting personnel and the invoice data being displayed in the invoice display area 114.

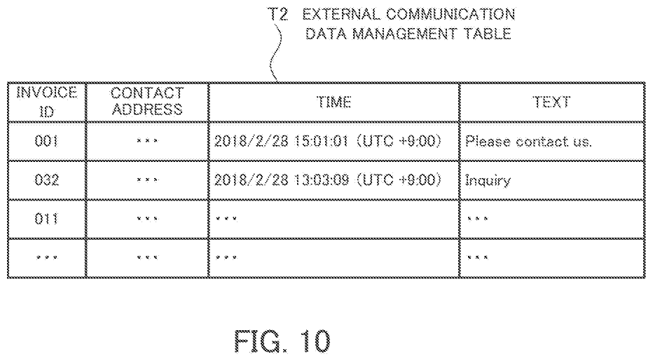

FIG. 10 is a view for explaining an example of external communication data.

In the present embodiment, external communication data is stored in tabular form.

The external communication data management table T2 has the following columns: Invoice ID, Contact Address, Time, and Text. Information pieces arranged in a horizontal direction are associated with each other.

The Invoice ID column contains the invoice ID of invoice data (invoice data associated with external communication data) that was displayed in the invoice display area 114 when the accounting personnel created the external communication data.

The Contact Address column contains the mail address of a creator that has created the external communication data.

The Time column contains the creation date and time of the external communication data.

The Text column contains the contents of the external communication.

In addition, in the external communication input mode, the data processing unit 11 refers to the external communication data management table T2 with respect to the invoice data being displayed in the invoice display area 114, and displays the external communications created so far, together with the fixed dates and times in chronological order in the information display area 121.

The information display area 121 displays external communications entered by the accounting personnel of both the sender and the recipient of the invoice data. Therefore, this external communication input mode enables these accounting personnel to perform communications like chats with each other.

In this connection, other processing (downloading, conversion to PDF format, and others) performed by the accounting personnel on the invoice data being displayed in the invoice data display area 114 may be indicated in the information display area 121 together with the execution dates and times of the processing. This enables both the accounting personnel to know the history on each other's processing.

### Attached File Button

When the accounting personnel selects the Attached File button 116, the data processing unit 11 switches the management screen 110 into an attached file mode. In this attached file mode, when the accounting personnel clicks and drags attached data into the information input area 112 and presses the enter key of the keyboard or the like to fix this operation, the data processing unit 11 stores the attached data in the attached file data storage unit 14 in association with the mail address of the accounting personnel and the invoice data being displayed in the invoice display area 114.

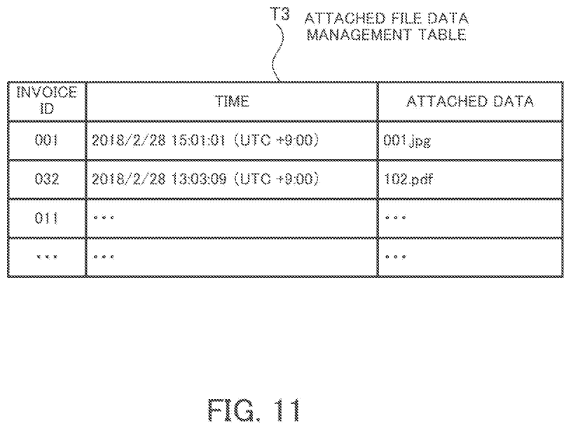

FIG. 11 is a view for explaining an example of attached file data.

In the present embodiment, attached file data is stored in tabular form.

The attached file data management table T3 has the following columns: Invoice ID, Time, and Attached Data. Information pieces arranged in a horizontal direction are associated with each other.

The Invoice ID column contains the invoice ID of invoice data (invoice data associated with attached data) that was displayed on a screen when the attached data was attached.

The Time column contains the attached date and time of the attached data.

The Attached Data column contains the name of the attached data.

In a file mode, the data processing unit 11 refers to the attached file data management table T3 with respect to invoice data being displayed in the invoice display area 114, and displays information about attached files attached so far, in chronological order in the information display area 121.

### History Button

The data processing unit 11 stores a history on operations made so far by the accounting personnel of both parties in the history data storage unit 15.

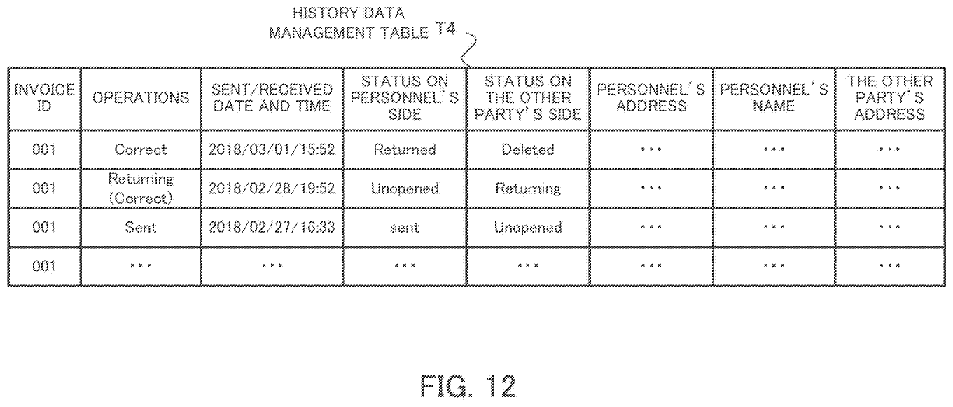

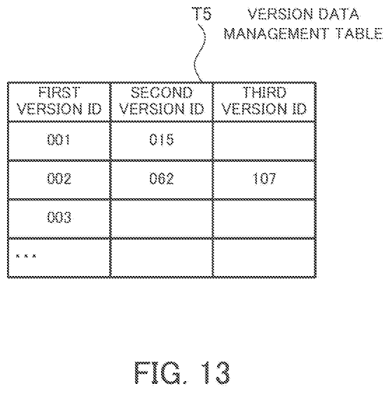

FIGS. 12 and 13 are views for explaining an example of data stored in the history data storage unit.

In the present embodiment, data is stored in tabular form.

The data processing unit 11 creates a history data management table T4 for each invoice data. In this connection, a different history data management table T4 is created for a different version.

The history data management table T4 has the following columns: Invoice ID, Operations, Send/Received Date and Time, Status on Personnel's Side, Status on the Other Party's Side, Personnel's Address, Contact Name, and The Other Party's Address. Information pieces arranged in a horizontal direction are associated with each other.

The Operations column contains an operation made by the accounting personnel. The other columns have the same contents as those of the invoice data management table T1, and therefore the description of these columns will not be repeated.

As illustrated in FIG. 12, the version data management table T5 has the following columns: First Version ID, Second Version ID, and Third Version ID. Information pieces arranged in a horizontal direction are associated with each other.

The First Version ID column contains an invoice ID that was given by the data processing unit 11 when the accounting personnel created invoice data and selected a Save button (not illustrated) on the management screen 110.

The Second Version ID column contains an invoice ID that was given by the data processing unit 11 when the accounting personnel created a second version based on the invoice data with the first version ID and selected the Save button (not illustrated) on the management screen 110.

The Third Version ID column contains an invoice ID that was given by the data processing unit 11 when the accounting personnel created a third version based on the invoice data with the second version ID and selected the Save button (not illustrated) on the management screen 110.

FIG. 12 illustrates columns up to the third version. If a fourth version of the invoice data is created, the data processing unit 11 adds an invoice ID of the created invoice data to a column of the version data management table T5. The same operation is performed for the fifth and subsequent versions.

When the accounting personnel selects the History button 117, the data processing unit 11 switches the management screen 110 to a history display mode. More specifically, the data processing unit 11 refers to the history data management table T4 and the version data management table T5, and displays a history about transactions of the invoice data being displayed in the invoice display area 114, in chronological order in the information display area 121.

### Memo Button

When the accounting personnel selects the Memo button 118, the data processing unit 11 switches the management screen 110 into a memo input mode. In this memo input mode, when the accounting personnel enters letters and so on in the information input area 122 and presses the enter key of the keyboard or the like to fix this operation, the data processing unit 11 stores the letters and so on as a memo in association with the mail address of the accounting personnel and the invoice data being displayed in the invoice display area 114 in the memo data storage unit 16. This memo is viewable only by the person who created the memo.

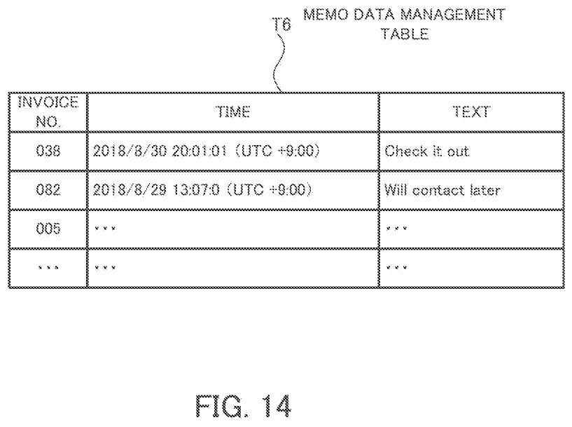

FIG. 14 is a view for explaining an example of memo data.

In the present embodiment, memo data is stored in tabular form.

The memo data management table T6 has the following columns: Invoice ID, Time, and Text. Information pieces arranged in a horizontal direction are associated with each other.

The Invoice ID column contains the invoice ID of invoice data (invoice data associated with a memo) that was displayed on a screen when the accounting personnel created the memo.

The Time column contains the creation date and time of the memo data.

The Text column contains the contents of the memo.

In addition, in the memo input mode, the data processing unit 11 accesses the memo data storage unit 16 to display memos created so far about invoice data being displayed in the invoice display area 114 in chronological order in the information display area 121.

Refer now back to FIG. 2 again.

### External Communication List Display Button

When the accounting personnel selects the External Communication List display button 119, the data processing unit 11 accesses the external communication data storage unit 13 storing therein data about external communications, and displays a list screen (external communication list screen) regarding external communications about invoices handled by the accounting personnel in chronological order on the management screen 110.

### Memo List Display Button

When the accounting personnel selects the Memo List display button 120, the data processing unit 11 accesses the memo data storage unit 16 storing therein data on external communications, to display a list screen (memo list screen) of memos regarding invoices handled by the accounting personnel in chronological order on the management screen 110.

The following describes how the invoice management apparatus 1 operates.

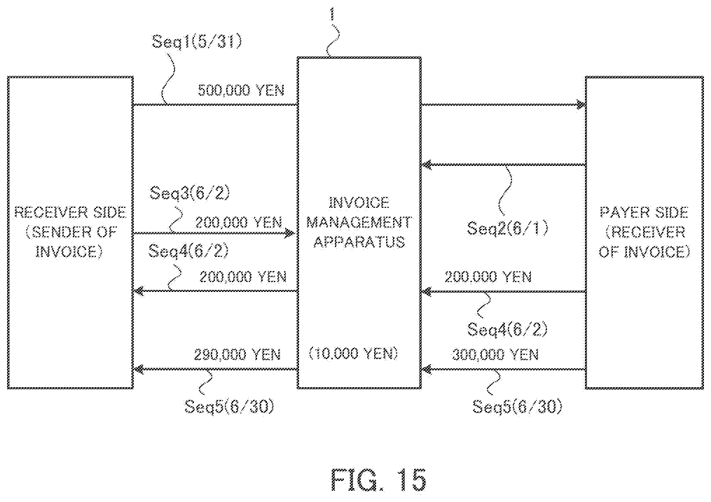

FIG. 15 is a view for explaining how the invoice management apparatus operates.

FIG. 15 illustrates an example where the accounting personnel at company A creates an invoice and sends it to the accounting personnel at company B. The amounts described below are just an example.

Sequence Seq 1. The accounting personnel at company A creates an invoice with a payment due date of Jun. 30, 3018 and a billing amount of 500,000 yen and sends this invoice to the accounting personnel at company B on May 31, 2018. At this time, the data processing unit 11 records the data about the invoice in the invoice data management table T1. In addition, the data processing unit 11 adds a record with the invoice ID and billing amount of the invoice in the credit and debt management table T8.

Sequence Seq 2. The accounting personnel at company B checks the invoice data on June 1 and selects the Confirm button 114b. At this time, the data processing unit 11 refers to the invoice data management table T1. Then, the data processing unit 11 changes the Status on the Other Party's Side to “confirmed” with respect to the invoice data. At this time point, the company A is able to receive the billing amount of 500,000 yen on the payment due date of June 30. That is, the change of the status to “confirmed” by the accounting personnel at company B gives the invoice management apparatus 1 a permission to withdraw the billing amount of 500,000 yen on the invoice from the account of company B.

Sequence Seq 3. On June 2, the accounting personnel at company A sends the invoice management apparatus 1 a notification indicating that the company A desires to receive in advance 200,000 yen out of the billing amount of 500,000 on the invoice created on May 31, 2018.

Sequence Seq 4. The data processing unit 11 refers to the invoice data management table T1 and determines based on the invoice ID whether the Status on the Other Party's Side is “confirmed.” The Status has been changed to “confirmed” at sequence Seq 2. Therefore, the data processing unit 11 accesses the management account of company B with reference to the account management table T7 to withdraw 200,000 yen therefrom and deposit this amount to the management account of company A. In this connection, the amount may be temporarily withdrawn from another account for pooling, not from the management account of company B, and then be deposited to the management account of company A.

Sequence Seq 5. The data processing unit 11 accesses the management account of company B with reference to the account management table T7 on the payment due date of June 30, and withdraws the remaining amount of 300,000 yen therefrom. Then, the information processing unit 11 deposits 290,000 yen after deducting a preset service charge of 10,000 yen, to the management account of company A. Then, the data processing unit 11 changes the Status on the Other Party's Side to “Paid” with respect to the invoice.

In this connection, FIG. 15 describes the example in which part of the billing amount is paid in advance to the company A. Alternatively, the amount after deducting the service charge from the billing amount may be paid in advance to the company A.

In addition, the service charge may depend on the timing of an advance payment request or a requested amount. For example, a higher service charge may be set for a large billing amount, and a higher service charge may be set for an earlier payment request date.

In addition, FIG. 15 describes the example the accounting personnel (issuer) at company A sends an advance payment request to the invoice management apparatus 1 at sequence Seq 3. Alternatively, the accounting personnel (receiver) at company B may send an advance payment request to the invoice management apparatus 1.

As described above, in the invoice management system 10, when invoice data addressed to a specified recipient is received from a terminal device over the network 50, the received invoice data is stored in association with the identification information of the recipient and the identification information of the issuer of the invoice data in the invoice data management table T1. In addition, intention information (confirmed) relating to the payment intention of the recipient is stored in this invoice data management table T1.

In addition, the data processing unit 11 is provided to refer to, upon receipt of a request for paying in advance at least part of the billing amount on the invoice data from either the issuer or the recipient, the invoice data management table T1 in order to confirm the intention information with reference to the Status on the Other Party's Side, and if the Status on the Other Party's Side indicates “confirmed” (the recipient has an intention for the payment), deposits the requested amount in advance to the designated account of the issuer, stores the paid amount and unpaid amount out of the billing amount on the invoice data in association with each other in the credit and debt management table T8, and deposits the unpaid amount stored in the credit and debt management table T8, to the designated account of the issuer on the payment due date.

This makes it possible to easily resolve the time lag between the issuance date and payment date of the invoice.

Note that invoice data is not communicated directly between the terminal devices 2a, 2b, and 2c. The invoice data created using the terminal devices 2a, 2b, and 2c and sent to bill-to parties is held by the invoice management apparatus 1 and is treated like shared data. Therefore, the accounting personnel of a bill-to party is able to obtain an original invoice by printing out the invoice data.

In addition, electronic signature processing, timestamp processing, and other processing are not needed, thereby making it possible to save labor for converting paper-based invoices to PDF files for tax inquiry.

The information display area 121 displays external communications made by the accounting personnel of both the sender and the recipient of invoice data. Therefore, using the external communication input mode enables the accounting personnel of both parties to perform communications like chats.

Information on invoice data is stored in the invoice data management table T1 when the invoice data is sent, and the statuses of subsequent transactions are managed using this invoice data management table T1. Therefore, the accounting personnel is able to get away from manually compiling invoices into a data sheet.

Note that the processing performed by the invoice management apparatus 1 may be performed in a distributed manner by a plurality of apparatuses.

In addition, in the embodiment, the invoice management apparatus 1 is provided with various storage units including the invoice data storage unit 12. The embodiment is not limited thereto, and cloud storage may be provided, instead of the various storage units, at a location different from the data processing unit 11.

Heretofore, the information processing apparatus and information processing method of the present invention have been described in the embodiment illustrated. The invention is not limited thereto, and the components of each unit may be replaced with other components having equivalent functions or other components. In addition, other desired configurations and steps may be added.

Further, two or more desired configurations (features) in the above-described embodiment may be combined.

The above-described processing functions may be implemented by using a computer. In this case, a program is prepared, which describes processes for the functions of the invoice management apparatus 1. A computer implements the above-described processing functions by executing the program. The program describing the intended processes may be recorded on a computer-readable recording medium. Computer-readable recording media include magnetic storage devices, optical discs, magneto-optical recording media, semiconductor memories, etc. The magnetic storage devices include HDDs, Flexible Disks (FD), Magnetic Tapes, etc. The optical discs include DVDs, DVD-RAMs, CD-ROMs, CD-RWs, etc. The magneto-optical recording media include MOs (Magneto-Optical disk), etc.

To distribute the program, portable recording media, such as DVDs and CD-ROMs, on which the program is recorded, may be put on sale. Alternatively, the program may be stored in the storage device of a server computer and may be transferred from the server computer to other computers over a network.

A computer which is to execute the above program stores in its local storage device the program recorded on a portable recording medium or transferred from the server computer, for example. Then, the computer reads the program from the local storage device, and runs the program. The computer may run the program directly from the portable recording medium. Also, while receiving the program being transferred from the server computer, the computer may sequentially run this program.

In addition, the above-described processing functions may also be implemented wholly or partly by using DSP (digital signal processor), ASIC (application-specific integrated circuit), PLD (programmable logic device), or other electronic circuits.

According to one aspect, it is possible to easily resolve the time lag between the issuance date of an invoice and the payment date of the invoice.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus comprising:
a first memory that stores therein, upon receipt of business document data addressed to a specified recipient, from a terminal device over a network, the received business document data in association with identification information of the recipient and identification information of an issuer of the business document data, and intention information about a payment intention of the recipient; and
a processing unit that is coupled to the first memory and is configured to perform a process including
accessing, upon receipt of a request for paying in advance at least part of a billing amount indicated in the business document data from the issuer or the recipient, the first memory to confirm the intention information,
paying in advance a requested amount to a designated account of the issuer upon determining that the recipient has a payment intention,
storing the paid amount and an unpaid amount out of the billing amount indicated in the business document data in association with each other in a second memory, and
paying the unpaid amount stored in the second memory to the designated account of the issuer on a payment due date,
wherein the process further includes storing the intention information in the first memory, based on an action made on business document data by the recipient actually viewing the business document data among the received business document data.

2. The information processing apparatus according to claim 1, wherein the process further includes enabling payment of the billing amount on the payment due date indicated in the business document data after the recipient confirms the business document data.

3. An information processing method comprising:
upon receipt of a request for paying in advance at least part of a billing amount indicated in business document data that is addressed to a specified recipient and sent from a terminal device, from an issuer or a recipient of the business document data,
accessing, by a computer, a first memory that stores therein, upon receipt of the business document data over a network, the received business document data in association with identification information of the recipient and identification information of the issuer of the business document data, and intention information about a payment intention of the recipient, in order to confirm the intention information,
paying, by the computer, in advance a requested amount to a designated account of the issuer upon determining that the recipient has a payment intention,
storing, by the computer, the paid amount and an unpaid amount out of the billing amount indicated in the business document data in association with each other in a second memory,
paying, by the computer, the unpaid amount stored in the second memory to the designated account of the issuer on a payment due date, and
storing, by the computer, the intention information in the first memory, based on an action made on business document data by the recipient actually viewing the business document data among the received business document data.

4. A non-transitory computer-readable storage medium storing a computer program that causes a computer to perform a process comprising:
upon receipt of a request for paying in advance at least part of a billing amount indicated in business document data that is addressed to a specified recipient and sent from a terminal device, from an issuer or a recipient of the business document data,
accessing a first memory that stores therein, upon receipt of the business document data over a network, the received business document data in association with identification information of the recipient and identification information of the issuer of the business document data, and intention information about a payment intention of the recipient, in order to confirm the intention information,
paying in advance a requested amount to a designated account of the issuer upon determining that the recipient has a payment intention,
storing the paid amount and an unpaid amount out of the billing amount indicated in the business document data in association with each other in a second memory, and
paying the unpaid amount stored in the second memory to the designated account of the issuer on a payment due date, and
storing the intention information in the first memory, based on an action made on business document data by the recipient actually viewing the business document data among the received business document data.
